(19) United States
(12) Patent Application Publication
(10) Pub. No.: US 2011/0214828 A1
(43) Pub. Date: Sep. 8, 2011

(54) PROCESS FOR MAKING A SECURITY DOCUMENT

(75) Inventor: Thibaut Le Loarer, Pommier de Beaurepaire (FR)

(73) Assignee: ARJOWIGGINS SECURITY, Paris (FR)

(21) Appl. No.: 13/123,456

(22) PCT Filed: Oct. 12, 2009
(86) PCT No.: PCT/IB09/54461

§ 371 Date: May 10, 2011

(30) Foreign Application Priority Data
Oct. 10, 2008 (FR) 08 56880

(51) Int. Cl. D21H 27/00; B44F 1/14

(52) U.S. Cl. 162/140

(57) ABSTRACT

A security document including a fibrous material formed in a paper machine, in which a security element is incorporated into the security document, including a step consisting in treating the security element, in-line at atmospheric pressure, with a plasma discharge just before it is incorporated into the fibrous material or transferred onto a sheet exiting the paper machine.

The present invention relates to security documents comprising paper, and especially to their manufacture.

In the description the term “paper” is understood to mean any sheet obtained by wet processing using a suspension of natural cellulose fibers and/or mineral, vegetable or organic (other than cellulose) and optionally synthetic fibers, possibly containing various fillers and various additives commonly used in papermaking.

### BACKGROUND

During the manufacture of a security sheet comprising one or more security elements either small security elements the width and length of which are about a few millimeters, for example such as planchettes which are flat elements made of plastic and/or paper, or such as colored or luminescent fibers, are introduced or a thin tape commonly called a “security thread” is introduced. This tape is generally made of plastic and comprises security elements, for example luminescent security elements,

Relatively small-format security elements such as fibers or planchettes may especially be introduced into a strip, if the paper machine is a Fourdrinier machine, by making a laminar jet containing a suspension of security elements flow over a sheet of paper undergoing formation which will subsequently be pressed then dried according to the common papermaking process. This process of introduction is described for example in patent application EP 1 253 241.

In the case of a paper machine equipped with a cylinder mold, the security elements may especially be introduced into a strip via supply ducts placed along the machine width and opening into the headbox near the cylinder mold, before draining of the fibrous suspension on the wire of the cylinder mold begins. After draining, a security sheet is obtained which is then pressed then dried according to the common papermaking process.

The security threads are incorporated inside the fibrous substrate forming the security sheet either “within the thickness”, i.e. the threads are completely covered by fibrous material, or “in windows”, the security threads then being partially located on the surface of the security sheet and partially within the thickness of the latter, for example in alternation. In particular, the windows thus described may or may not be through-windows, depending on whether the security thread appears on both sides or on only one side, respectively, of the security sheet.

Introduction of the security threads into the thickness may especially be carried out using a single ply, on a Fourdrinier machine or cylinder mold. In the case of a cylinder mold, the thread is introduced into the headbox before or just after the start of the drainage of the fibrous suspension on the wire. The position of the security thread in the thickness of the final security sheet is especially determined by the place and inclination of the introduction of the security thread. The ply thus obtained may then be combined in the wet state, i.e. before drying, with other plies the fibrous compositions of which may be identical or different and which may be formed in Fourdrinier or cylinder mold paper machines.

Another way of introducing security threads into the thickness is to incorporate them between two successive plies produced on a Fourdrinier table and/or cylinder mold, before “combining” the successive plies by pressing in the wet state. The plies may themselves be combined with other plies the compositions of which may be identical or different and which may be formed on a Fourdrinier table or cylinder mold, before or after the introduction of the security threads. After they are combined, the two successive plies comprising the security threads are optionally combined with other plies and then dried according to the common papermaking process, allowing a security sheet to be obtained.

The introduction of a security thread in windows in a single ply is for example described in patent applications EP 059 056, for a cylinder mold paper machine, and EP 0 609 252, for a Fourdrinier machine. The introduction in windows between two plies of a multiply fibrous material is described in the patent application EP 0 229 645.

The introduction of security threads may especially cause poor coverage of the security threads, characterized, when they are introduced into the thickness, by a lack of material above the security threads and, when they are introduced in windows, by insufficient bridging, also called “broken bridges”. The term “bridging” is understood to mean the fibrous covering of a security thread, introduced in windows, in the regions between the windows, i.e. the positions where the thread is contained in the thickness of the security sheet. These broken bridges are all the more pronounced when the security sheet into which the security threads are introduced has a low basis weight.

This broken bridge effect results in particular in a visually defective and weaker security sheet, thus comprising a drawback of security sheets of the prior art containing security threads.

Solutions have been proposed for improving the adhesion of a security element to paper fibers during its incorporation. For example, applying a lacquer to the security element has been envisioned. However, in the case of a security thread comprising a microlens array, i.e. microreliefs, the cause of a very low wettability (also called the “lotus effect”), applying varnish may reduce or cancel the lens effect and therefore the security provided by the thread.

Moreover, plasma or corona treatments are known to increase the surface energy, i.e. increase the wettability, of many materials such as metal, wood, polymers or paper.

Depending on the circumstances, the material to be treated is placed in a vacuum chamber or remains at atmospheric pressure. The plasma may be said to be “hot” when it is completely ionized and composed only of ions and electrons as is the case of the Sun, or “cold” when it is only partially ionized and composed of ions, electrons and neutral particles (atoms, molecules, metastable radicals). The term “plasma” is understood to mean, in this application, a cold plasma that is not in thermodynamic equilibrium, i.e. a partially ionized gas where the electrons are the most energetic particles.

Plasma-surface interactions lead to reactions at the surface which may cause the physical-chemical properties of the treated substrates to be modified. The plasma especially produces high-energy particles such as electrons and UV and visible radiation, but also ions and excited particles. Exposing a surface to a plasma may thus lead to a modification of the surface via the breaking of chemical bonds and by the formation of free radicals. These radicals will be able to react allowing functional chemical groups to form depending on the nature of the plasma discharge. Depending on the discharge gas used, the treatment will be termed activation when the main effect is the cleaning of the surface, or termed deposition when the surface is grafted with or covered by new chemical function groups.

Application WO 2005/026440 describes a security element intended to be incorporated in a security document, the security element comprising a fibrous film possibly subjected to a plasma or corona pretreatment so as to increase the polarization of the fibers of the fibrous film.

Application WO 03/044276 describes a security article comprising a security element the surface of which may be treated by a low-pressure plasma treatment with the object of modifying the surface of the security element, by the removal of an element from the surface of the security element or the addition of an element thereto, for example by fluorination or roughening of the treated surface.

The use of a plasma treatment, for example allowing fluorine to be added to the surface of a security element, imposes specific working condition, especially making in-line treatment on a paper machine at atmospheric pressure impossible—in particular due to the risks associated with fluorine molecules. Likewise, the in-line treatment of a security element by a low-pressure plasma treatment on a paper machine leads to constraints and production difficulties on account of the conventional equipment used for manufacturing security paper.

Corona treatment is distinguished from plasma treatment by the density of active species involved and by the uniformity of the treatment.

In the papermaking industry in particular, plasma and corona treatments may be used as activation treatments, thus allowing the surface to be treated to be modified, for example making the surface energy of a substrate uniform before coating, sterilizing paper or nonwoven substrates, improving impregnation by increasing the wettability of the substrate, or else producing thin films on the surface of a substrate using a deposition or grafting treatment.

Activation treatments mainly consist in cleaning the surface, i.e. a “descum” of the surface at the atomic level allowing surface pollutants, present naturally in the ambient air, to be removed, this effect being combined with an oxidation of the material allowing an overall increase in the surface energy and therefore in the wettability by virtue of a more reactive surface. Nevertheless, such a surface exposed once more to contaminants will react in a very short space of time and in fine “again become” a polluted, low-surface-energy surface. The effect of a plasma treatment is thus optimal immediately after the treatment and its effect decreases very rapidly as a function of time.

The applicant has conducted trials consisting in treating a security thread with an atmospheric-pressure plasma, such as the microlens array threads sold by Crane & Co under the trademark Motion®. The increase in the wettability of such a thread was observed, nevertheless the treatment did not show any notable improvement relative to the problem of making the thread adhere to the fibrous substrate when it was introduced into a paper machine a few days later.

### SUMMARY

There is a need to obviate at least some of the aforementioned drawbacks, especially to improve the compatibility of a security element with the paper fibers of a security document, especially the adhesion of the security element to the paper fibers.

The invention thus aims to make the incorporation of security elements into a security document easier, especially by activation treatment of the security elements.

One subject of the invention, according to one of its aspects, is a process for manufacturing a security document comprising a fibrous material formed in a paper machine, in which a security element is incorporated into the security document, this process comprising a step consisting in treating the security element, in-line, with a plasma discharge just before it is incorporated into the fibrous material or transferred onto a sheet exiting the paper machine. In particular, the treatment step is carried out on the production line of the fibrous material.

By virtue of the invention it is possible to improve the adhesion of the security element to the security document, to prevent air bubbles appearing between the security element and the paper fibers and to stop the security element from debanding or being torn off.

Without being tied to one theory, the applicant explains the improvement surprisingly obtained by virtue of the invention by the fact that the effectiveness of the plasma treatment decreases with time. Thus, by treating the security element in-line, just before it is integrated into the paper thickness or introduced into the circuit of the paper machine, the effect of the treatment remains substantial when the security element makes contact with the fibrous material.

In the case of an elongate security element such as a security tape or thread, the treatment is especially carried out just before the security element is introduced into the paper thickness, i.e. before the sheet is formed on the paper machine.

In the case of relatively small-format security elements such as security fibers or planchettes, the treatment may be carried out just before the paper thickness is formed, the security elements being for example dispersed in water then integrated into the paper thickness via the water-supply circuit. The security elements may also be projected onto the sheet of paper undergoing formation by a laminar jet containing a suspension of security elements. The plasma treatment carried out at this point in the process especially allows the dispersion of the security elements to be improved while improving their adhesion in the paper thickness.

The treatment may be chosen from plasma or corona treatments, as defined above, which allow the surface energy of the security element to be increased.

The plasma treatment may be a dielectric-barrier discharge (DBD) plasma treatment, whether the plasma is transported by a gas flow or not. Such a treatment may especially have the advantage of having a higher density of active species than other treatments, especially a corona treatment. In addition, a dielectric-barrier discharge plasma treatment may allow a uniform discharge to be produced, thereby especially having the advantage of preventing electric arcs from forming and heating the treated security element.

The plasma treatment may be static, i.e. carried out within an atmospheric-pressure or low-pressure treatment reactor in which the treated security element stays for a defined time, or dynamic—also called roll-to-roll or on-the-run processing—i.e. carried out within an atmospheric-pressure reactor through which the treated security element passes, without spending any time stopped inside of this reactor.

The plasma treatment may be carried out using a fluidized bed. The treatment of the security fibers and planchettes may in particular be carried out in a fluidized bed reactor.

The plasma treatment may for example be carried out using Plasmatreat, Enercon, Dow Plasma, Diener, Apit Technologic, Grinp, Airliquide, Ahlbrandt or Acxys equipment.

The treatment may be carried out at atmospheric pressure, i.e. without a pumping system being present. In this way, it is easier to carry out the treatment in-line during the manufacture of the security document.

Advantageously, the amount of time separating the treatment of the security element and its incorporation into the security document is as short as possible, for example about a few seconds, especially less than 60 seconds.

The amount of time separating the plasma treatment and the incorporation of the security element of the thread may be that required, taking account of the continuous run speed of the security element, for the treated region to reach the fibrous suspension.

The process according to the invention may comprise a step of printing and/or coating the security element after plasma treatment. This step may occur before or after incorporation of the security element into the fibrous suspension in a cylinder mold or Fourdrinier paper machine.

A conventional or security ink may thus be applied onto the security element, especially a fluorescent, phosphorescent, magnetic, photochromic, thermochromic, piezochromic or iridescent ink, inter alia. The ink may be applied partially or completely onto the security element, i.e. only on certain regions or over the entire surface of the element. The ink may be applied by any known printing means, for example offset, rotogravure, screen or inkjet printing.

The plasma treatment may correspond to a dielectric-barrier discharge discharge plasma treatment, an inductively coupled plasma treatment, a radiofrequency plasma treatment, a capacitively coupled plasma treatment or a microwave plasma treatment, inter alia.

The plasma treatment may be a remote-discharge treatment, i.e. a treatment in which the security element is directly treated by the ionized gas produced, outside of the inter-electrode space.

The treatment is advantageously a remote-plasma treatment, also called a “blown-arc plasma” treatment, i.e. a treatment in which the plasma is generated and then blown onto the security element using a gas flow.

The plasma treatment may also be a volume plasma treatment, i.e. a treatment where the security element is treated in the inter-electrode space.

The plasma treatment may be carried out in a confined space, especially so as not to interfere with the introduction of the security element into the security document on the production line.

The security element or elements may be chosen from security fibers or planchettes, highlights, security threads or security foils. The security element may be introduced in windows. As a variant, the security element may be introduced into the thickness, i.e. being completely covered by the fibers of the security document.

The security element may also be introduced onto the surface of the security document, i.e. so that one of its sides is entirely visible on the security document.

The security element may be nonfibrous

According to a particular embodiment of the invention, the security element comprises a microrelief, for example a microlens array.

When the security element is a security thread, it has for example a width of less than 15 mm and a thickness of between 5 and 45 μm.

The security thread may extend over the entirety of one dimension (width or length) of the document, such as it is introduced onto the market.

The security element may be protected by positive and/or negative patterns whether visible or not, by optically variable devices, in particular holograms, by magnetism, or by electrical conduction. The security element may also comprise an optical effect such as for example iridescence, fluorescence, photochromism, thermochromism and triboehromism.

The security element may comprise a thermoplastic substrate, for example made of PE, PET, PC, PES or PVC. The security element may be coated with an adhesive before being introduced into the security document, especially into the fibrous suspension in a cylinder mold machine, especially a heat-activated heat-sealing product.

The coating must take place before the plasma treatment in order to obtain the best possible adhesion when the security element is introduced into the fibrous suspension.

The security document may be a means of payment such as a banknote, a check, or a restaurant voucher, an identity document such as an identity card, a visa, a passport, or a driving license, a lottery ticket, a travel ticket, tickets for entry to cultural or sporting events, a playing card or else a collectable card.

Another subject of the invention is a process for treating a security element, for example a security thread or a security foil, comprising the step consisting in exposing it to a plasma discharge, especially a plasma as defined above.

The invention will be better understood on reading the following description of nonlimiting examples of methods of implementing it, and on examining the appended schematic, partial drawings, in which:

FIG. 1 illustrates the treatment of a security element according to the invention;

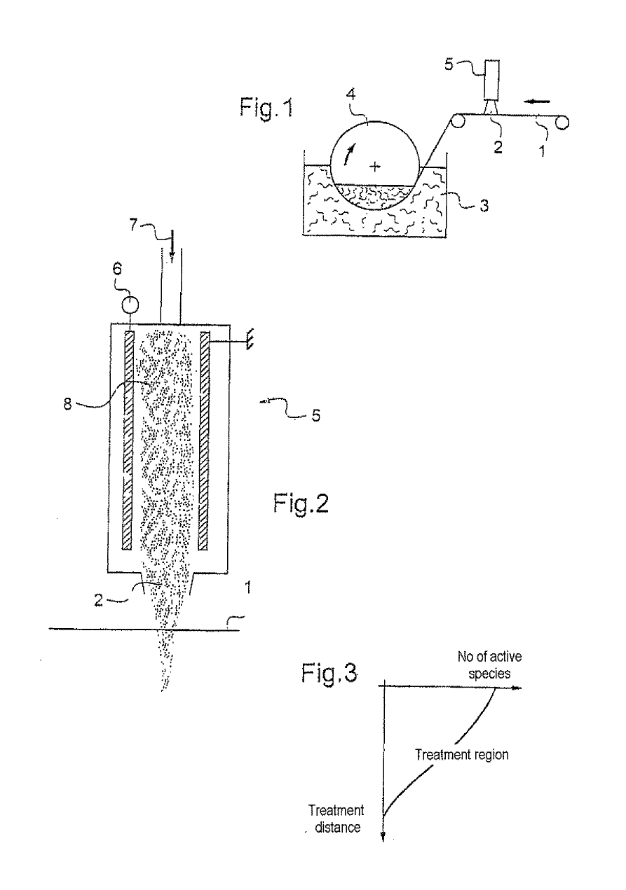

FIG. 2 shows an exemplary device allowing an ionized gas to be discharged onto the security element;

FIG. 3 is a graph showing the density of active species in the ionized gas as a function of the treatment distance; and

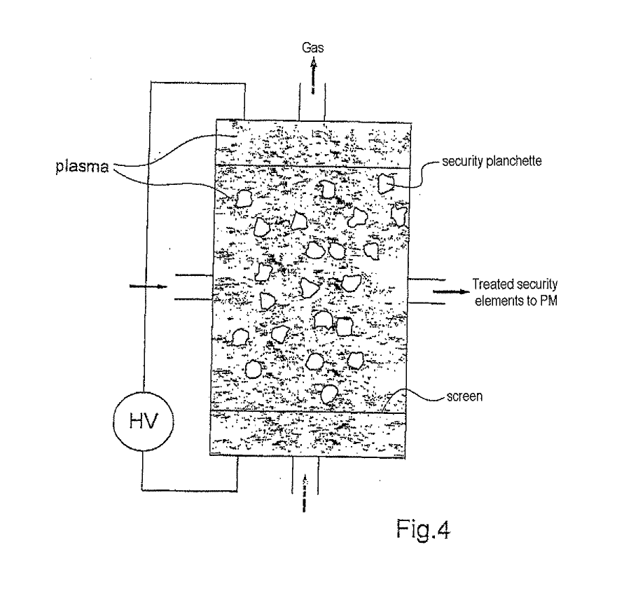

FIG. 4 shows an exemplary fluidized-bed plasma treatment of a security element.

Illustrated in FIG. 1 is an exemplary treatment of a security element 1 according to the invention.

In this example, the security element 1 corresponds to a security thread which is introduced into a fibrous suspension 3 of a cylinder mold paper machine 4.

As may be seen in FIG. 1, the security thread 1 is subject to a plasma 2 discharge treatment, generated by a device 5 placed upstream of the incorporation of the security thread 1 into the fibrous suspension 3 of the paper machine. The plasma discharge treatment is carried out in-line on the paper machine and at atmospheric pressure.

The security thread 1 obtained after treatment by the plasma 2 has improved adhesion properties.

The process may, if required, comprise a step of printing the security thread 1 after plasma treatment 2 and before incorporation into the fibrous suspension 3.

A device 5, allowing the treatment of the security thread 1 by plasma 2 discharge, is shown in FIG. 2.

This device 5 comprises an inlet for compressed air 7 and a high-frequency sinusoidal current generator 6 allowing the compressed air 7 to be excited and sustained so as to give rise to the active species 8 which form the plasma 2 blown onto the security thread 1.

Shown in FIG. 3 is a graph showing the variation in the number of active species 8 contained in the plasma 2 as a function of the treatment distance from the security thread 1.

As may be seen in this graph, the shorter the treatment distance between the device 5 and the security thread 1, the larger the number of active species 8 contained in the plasma 2.

The choice of the treatment distance of the security thread 1 will be a compromise between the number of active species 8 and the thermal effect on the security thread 1.

A device X allowing security planchettes to be treated by plasma discharge in a fluidized bed reactor is shown in FIG. 4.

This device comprises a reactor with a gas inlet/outlet (treatment gas or air), a high-frequency generator allowing the plasma discharge to be sustained and an inlet/outlet allowing security elements to circulate in the reactor.

### EXAMPLE 1

A remote-discharge plasma treatment was carried out at atmospheric pressure on a Motion® security thread, sold by Crane & Co, just before its introduction into a fibrous suspension in a cylinder mold paper machine. The 2- to 4-second time lapse separating the plasma treatment and the immersion in the fibrous material corresponded to the travel time of the thread due to its run speed, for example lying between 40 and 60 m/min.

The treatment was for example carried out using an OpenAir® system sold by Plasmatreat, a Plasmastream® system sold by Dow Corning Plasma, or else a ULS series system sold by Acxys. Any other atmospheric-pressure plasma treatment system, whether a remote-discharge system or not, allowing a thread to be treated might also be used.

The security thread used was for example a microlens array thread, i.e. a thread comprising microstructures responsible for a poor wettability of the security thread. The microlens array allows an animation to be created on the thread when the viewing angle is varied.

The plasma treatment allows the surface energy of the security thread to be temporarily increased, i.e. to produce an effect combining cleaning and oxidation of the outermost surface of the security thread, defined as being the first tens of nanometers of the thread, thus allowing the wettability of the security thread, and therefore its adhesion in the paper mass, to be increased.

### EXAMPLE 2

A plasma treatment was carried out on a security foil intended to be incorporated into a security document, for example a meal voucher.

The plasma treatment allows the printability of the foil to be improved, the latter possibly being printed with an ink curable under ultraviolet (UV) light.

The treatment allows the surface energy to be increased and the outermost surface of the security thread to be cleaned allowing a more uniform surface and a better wettability to be obtained, thus making adhesion of the ink, one deposited on the security foil, easier.

The invention is not limited to the examples described and it is possible to produce the treatment using a surface plasma or a corona, etc.

The term “comprising” is understood to be synonymous with the expression “comprising at least one”.

### EXAMPLE 3

A plasma treatment was carried out on security planchettes, for example iridescent security planchettes intended to be incorporated into banknotes.

A plasma was blown through the reactor thereby “fluidizing” the security planchettes held in the reactor using two gratings at the gas inlet and outlet. The device was also provided with an inlet allowing security elements to be supplied, whether continuous or not, and an outlet allowing treated security elements to be transferred into the circuit of the paper machine.

Such a process could also be carried out on fibers or other relatively small-format elements such as, for example, highlights.

The plasma treatment allows the wettability of the planchettes, during their introduction into the paper thickness, to be increased and therefore allows a better adhesion of the planchettes in the paper to be obtained.

1. A process for manufacturing a security document comprising a fibrous material formed in a paper machine, in which a security element is incorporated into the security document, comprising treating the security element, in-line at atmospheric pressure, with a plasma discharge just before it is incorporated into the fibrous material or transferred onto a sheet exiting the paper machine.

2. The process as claimed in claim 1, the plasma treatment being a dielectric-barrier discharge plasma treatment.

3. The process as claimed in claim 1, the plasma treatment being carried out using a fluidized bed.

4. The process as claimed in claim 1, comprising a step of printing the security element after plasma treatment and before incorporation into the fibrous material.

5. The process as claimed in claim 1, comprising a step of coating the security element after plasma treatment and before incorporation into the fibrous material.

6. The process as claimed in claim 1, the treatment being carried out in remote-discharge mode.

7. The process as claimed in claim 1, the security element being a security thread or a security foil.

8. The process as claimed in claim 1, the security element being security planchettes or fibers.

9. The process as claimed in claim 1, the security element being introduced into windows in the security document.

10. The process as claimed in claim 1, the security element being introduced into the thickness of the security document.

11. The process as claimed in claim 1, the security element being introduced onto the surface of the security document

12. The process as claimed in claim 1, the security element comprising a microrelief.

13. The process as claimed in claim 12, the security element comprising a microlens array.

14. The process as claimed in claim 12, the security element comprising at least one optical effect.

15. The process as claimed in claim 14, the optical effect being chosen from iridescence, fluorescence, photochromism, thermochromism and tribochromism.
